(19) United States
(12) Patent Application Publication
(10) Pub. No.: US 2007/0127737 A1
(43) Pub. Date: Jun. 7, 2007

(54) Audio/video system

(75) Inventor: Chang-Hung Lee, Yuan Lin Hsien (TW)

Correspondence Address: LADAS & PARRY, 26 WEST 61ST STREET, NEW YORK, NY, 10023, US

(73) Assignee: BENQ CORPORATION

(21) Appl. No.: 11/604,610

(22) Filed: Nov. 27, 2006

(30) Foreign Application Priority Data
Nov. 25, 2005 (TW) 94141558

(51) Int. Cl. H04B 15/00

(52) U.S. Cl. 381/94.3

(57) ABSTRACT

An audio/video system is disclosed. The audio adjusting system is applied to an audio/video device, which produces a first audio signal and a video signal. The audio/video system comprises: an environment analysis unit, which receives at least one environmental data set and produces an environmental adjusting parameter according to the environmental data set; a volume control unit generates a second audio signal according to the environmental adjusting parameter and the first audio signal; and an SNR computing unit for calculating an SNR according to the second audio signal and an environmental volume magnitude, the SNR is for adjusting the output value of the second audio signal.

### BACKGROUND OF THE INVENTION

(1) Field of the Invention

The invention relates to an audio/video system, and more particularly to an audio/video system that can adjust volume magnitude according to characteristic data sets.

(2) Description of the Prior Art

Modern people usually watch or listen to audio/video devices, for example, televisions are as their entertainments. The audio/video devices can play motion pictures and voices. With the development of various displays and visual processing technology, the advance of multi-channel audio systems, and the audio encoding/decoding technology, people can physically feel the more stereo effect. But whether the volume magnitude of voice is appropriate or not can determine the perceptions of users.

When watching TV programs, the audience always adjusts the volume by means of a controller due to the variable volume magnitudes The reason is that the adjustment of the volume may depend on the environmental noise as always. Accordingly the volume magnitude for the ears of human being is related to SNR (Signal to Noise). That is, when the environmental noise is higher, the volume magnitude may be higher relatively; otherwise, when the environmental noise is lower, the volume magnitude must be lower as well so as to achieve an appropriate volume magnitude. Therefore, how to automatically adjust the volume magnitude based on the SNR that is sensed is the first priority of research and development engineers.

Please refer to FIG. 1A, which illustrates a schematic system structural view of an audio/video system in prior arts. As shown in FIG. 1, an audio/video system 1 includes a volume control unit 12 and an SNR computing unit 13 for adjusting the volume magnitude of a first audio signal that is outputted by an audio source 14. The audio source 14 outputs the first audio signal to the volume control unit 12. The volume control unit 12 is controlled by the SNR computing unit 13 in order to change the first audio signal to a second audio signal and output to a speaker 111. A microphone 112 is used to capture an environmental volume magnitude and output to the SNR computing unit 13. The environmental volume magnitude includes an output voice from the speaker 111 and external noise. The SNR computing unit 13 is connected to an output terminal of the volume control unit 12 so as to input the second audio signal. Therefore, the SNR computing unit 13 calculates an SNR and further controls the volume control unit 12. That is, when the SNR is higher, the output value of the second audio signal is lower; otherwise, the output value of the second audio signal is higher.

The SNR computing unit 13 can be achieved by various electronic circuits. Taking Japanese Patent No. 05-30588 as an example. With reference to FIG. 1B, which illustrates an electronic circuits block diagram of an audio/video system of the Japanese Patent No. 05-30588. As shown in FIG. 1B, an audio source 14 outputs a first audio signal to a first amplifier 121. The first amplifier 121 is controlled by a micro computer 137 and adjusts the first audio signal to a second audio signal, then transmits the second audio signal to the speaker 111. A microphone 112 senses noise and the output voice of the speakers, then adjusts the gain of signals through a second amplifier 134, and inputs the signals to an adder 133. On the contrary, an inverter 131 is connected to an output terminal of the first amplifier 121 to sense the second audio signal. After the second audio signal is inverted by the inverter 131 and a voltage level thereof is adjusted by a compensated circuit 132, then the second audio signal is inputted into the adder 133. Therefore, the adder 133 is capable of computing a noise value, and then the noise value is inputted into an integrator 135 for an integration operation. After integration, the integration value is converted into a digital noise adjusting parameter by an analog/digital converter 136, and is inputted into a micro computer 137. An audio control source 130 is used to input an initial volume control signal into the micro computer 137. The micro computer 137 controls, according to the initial volume control signal and the digital noise adjustment parameter, the gain of the volume adjustment through the first amplifier 121.

Therefore, the audio/video system 1 can automatically adjust the volume magnitude according to the SNR. Audiences do not use the remote controllers to adjust the volume magnitudes. Such design brings the convenience to the audiences. However, in addition to the SNR, the volume magnitude required by people also relates to other environmental changes. The environmental changes include audiences' mood, space, program contents, etc.

Nowadays, artificial intelligence is getting more and more mature, and there are various sensors and affective computing algorithm that can sense and judge data, such as mood of human being and identification characteristics. Additionally, through the motion analysis of the programs, the contents of the programs is recognized. To add the function of the environmental detection is able to monitor the moods of the audiences and the contents of the programs and actively adjust the gain of the volume adjustment in order to improve the quality of the audio/video system. It is an important issue what the inventor of the present invention has being working on.

### SUMMARY OF THE INVENTION

It is an object of the present invention to provide an audio/video system, which can detect characteristic data sets, and dynamically adjust volume magnitude to provide the high quality of an audio/video effect.

The present invention discloses an audio/video system. The audio/video system has a first audio signal and a video signal. The audio/video system comprises an environment analysis unit, a volume control unit, and an SNR computing unit. The environment analysis unit receives at least one characteristic data set and produces an environmental adjusting parameter according to the environmental data set. The volume control unit generates a second audio signal according to the environmental adjusting parameter and the first audio signal. The SNR computing unit calculates an SNR according to the second audio signal and an environmental volume magnitude, the SNR is for adjusting an output value of the second audio signal.

The audio/video system further includes a speaker. The volume control unit outputs the second audio signal to the speaker. The SNR computing unit further includes a sound detecting module. The sound detecting module is to sense the environmental volume magnitude. The environmental volume magnitude is a sum of the magnitude of the second audio signal outputted by the speaker and a noise value. The SNR is a ratio of the second audio signal to the noise value. When the SNR is lower, the outputting value of the second audio signal is adjusted to be higher; otherwise, the outputting value of the second audio signal is lower as well.

The environment analysis unit further includes a storage device, which is used to store a plurality of characteristic data sets and a plurality of corresponding environmental adjusting parameters.

In a preferred embodiment of the present invention, the environment analysis unit includes a set up interface. Through the set up interface, an audience can set up a first environmental data set, including the age and sex of the audience, the environment analysis unit selects a first environmental adjusting parameter from the plurality of environmental adjusting parameters according to the first environmental data set environment analysis unit.

In other embodiment of the present invention, the environment analysis unit includes an image capture device and a comparison unit. The storage unit stores a plurality of images corresponding to the plurality of environmental adjusting parameters. The image capture device is to capture a first image. The comparison unit is to compare the first image with the plurality of images. when a minimum discrepancy is between a second image and the first image among the plurality of images, the environment analysis unit selects a second environmental adjusting parameter from the plurality of environmental adjusting parameters according to the second image and transmits the second environmental adjusting parameter to the volume control unit.

In other embodiment of the present invention, the environment analysis unit includes a space detecting device, which is used to detect a space value; wherein the environment analysis unit selects a third environmental adjusting parameter from the plurality of the environmental adjusting parameters according to the space value.

In other embodiment of the present invention, the environment analysis unit integrates the first audio signal in a unit time to produce the environmental adjusting parameter environment analysis unit.

As aforesaid, in addition to adjusting the volume according to the environmental SNR, the environment analysis unit that is used to receive various characteristic data sets to further adjust volume magnitudes. The characteristic data sets includes the age, sex, title, emotion, etc. of the audience and the program contents. Through the present invention, the audio adjusting mechanism of the audio/video system can be brought into a new stage.

### BRIEF DESCRIPTION OF THE DRAWINGS

The present invention will now be specified with reference to its preferred embodiment illustrated in the drawings, in which:

FIG. 1A illustrates a schematic system structural view of an audio/video system in prior arts;

FIG. 1B illustrates an electronic circuits block diagram of an audio/video system of the Japanese Patent No. 05-30588;

FIG. 2 illustrates a schematic system block diagram of an audio/video system of the present invention;

FIG. 3 illustrates a schematic system block diagram of a first preferred embodiment of the audio/video system of the present invention;

FIG. 4 illustrates a schematic system block diagram of a second preferred embodiment of the audio/video system of the present invention;

FIG. 5 illustrates a schematic system block diagram of a preferred third embodiment of the audio/video system of the present invention; and

FIGS. 6A and 6B both illustrate two schematic system block diagrams of a forth preferred embodiment of the audio/video system of the present invention.

### DESCRIPTION OF THE PREFERRED EMBODIMENTS

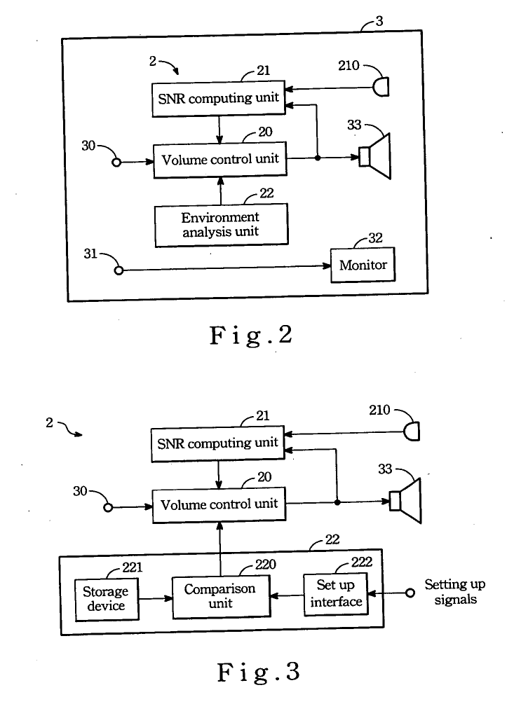

Firstly, please refer to FIG. 2, which illustrates a schematic system block diagram of an audio/video system of the present invention. As shown in FIG. 2, an audio/video play device 3 has an audio signal source 30 and a video signal source 31. The audio/video play device 3 can be a television, which receives a video signal. After the audio/video play device 3 decodes the video signal, a first audio signal and a video signal are produced. The audio signal source 30 outputs the first audio signal to an audio/video system 2, and the video signal source 31 outputs the video signal to a monitor 32.

The audio/video system 2 includes an environment analysis unit 22, a volume control unit 20, and an SNR computing unit 21. The environment analysis unit 22 can receive at least one characteristic data sets, and produce an environmental adjusting parameter according to the environmental data set. The volume control unit 20 generates a second audio signal according to the environmental adjusting parameter and the first audio signal. The SNR computing unit 21 calculates an SNR according to the second audio signal and an environmental volume magnitude, the SNR is for adjusting an output value of the second audio signal.

In FIG. 2, the audio/video play device 3 includes a speaker 33. The volume control unit 20 outputs the second audio signal to the speaker 33. The SNR computing unit 21 further includes a sound detecting module 210, which is usually a microphone that can be an electric type, a carbon powder type, a capacity type, or a piezoelectric type for sensing voice signal. The sound detecting module 210 is used to detect the environmental volume magnitude. The environmental volume magnitude is a sum of the second audio signal magnitude outputted by the speaker 33, and of a noise value. The SNR computing unit 21 is to calculate the SNR according to the second audio signal and the environmental volume magnitude, and further adjust the output value of the second audio signal. The SNR is a ration of the second audio signal to the noise value. When the SNR is lower, the output value of the second audio signal is adjusted to be higher. When the SNR is higher, the output value of the second audio signal is adjusted to be lower.

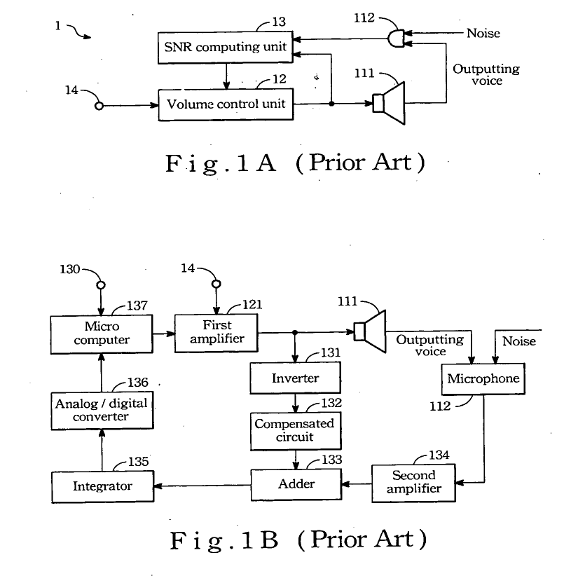

The detailed descriptions have been disclosed in the FIG. 1A and FIG. 1B in the prior art, and thus are disregarded here. With reference to FIG. 2, the SNR computing unit 21 is connected to an output terminal of the volume control unit 20 to input the second audio signal. But in practice, a voice sending device (not shown) can be installed in the speakers 33, so that the second audio signal can be captured more accurately.

Again, please refer to FIG. 3 which illustrates a schematic system block diagram of a first preferred embodiment of the audio/video system of the present invention. As shown in FIG. 3, the environment analysis unit 22 includes a storage device 221, a set up interface 222, and a comparison unit 220. The storage device 221 includes a non-volatile memory for storing a plurality of characteristic data sets and a plurality of corresponding environmental adjusting parameters. The audience can input a set up signal through the set up interface 222, so the characteristic data sets can be inputted into the environment analysis unit 22, in which the characteristic data sets include the age, sex, identification, etc. of the audience. The comparison unit 220 is for comparing the first image with the plurality of images, when a minimum discrepancy between a second image and the first image among the plurality of images, the environment analysis unit 22 selects a second environmental adjusting parameter from the plurality of environmental adjusting parameters according to the second image and transmits the second environmental adjusting parameter to the volume control unit 20, so that the volume control unit 20 can further adjust magnitude of the second audio signal according to characteristics of the different audiences.

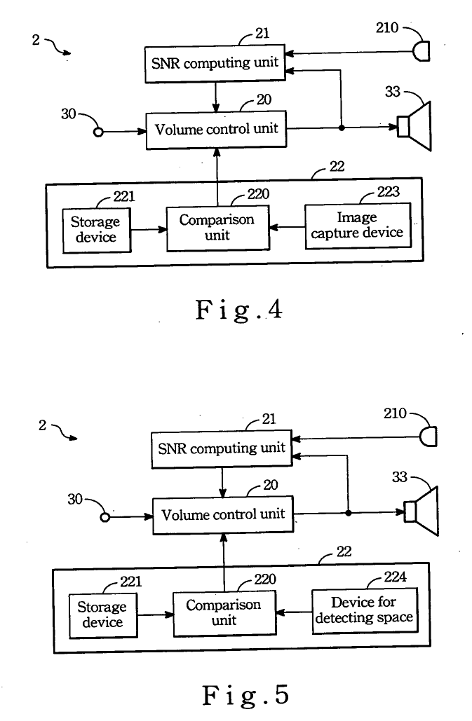

In addition to audience's set-up actively, the characteristic data sets includes audience's mood, such as happiness, anger, sadness, delight, etc. Please refer to FIG. 4 which illustrates a schematic system block diagram of a second preferred embodiment of the audio/video system of the present invention. As shown in the figure, the environment analysis unit 22 includes a storage device 221, an image capture device 223, and a comparison unit 220. The image capture device 223 can be a charge couple device (CCD) or a complementary metal oxide semiconductor (CMOS) image sensor for capturing the images of the facial expressions and body movement of the audience, in which a first image is included. The storage device 221 stores the plurality of the environmental adjusting parameters corresponding to the plurality of images. The comparison unit 220 is for comparing the first image with the plurality of images, when a minimum discrepancy between a second image and the first image among the plurality of images, the environment analysis unit 22 selects a second environmental adjusting parameter from the plurality of environmental adjusting parameters according to the second image and transmits the second environmental adjusting parameter to the volume control unit 20.

In the second embodiment, through capturing facial expressions, body movement of the audience and even the mood of the audience, a judgment is made to further adjust the volume. Therefore, when the audience laughs or claps hands, the volume magnitude is adjusted to be higher so as to achieve a better effect. Hardware and software, which are applied to recognize facial expressions and body movement, are widely used and see recently.

Please refer to FIG. 5 which illustrates a schematic system block diagram of a third preferred embodiment of the audio/video system of the present invention. The third embodiment discloses the adjustment of the volume magnitude according to the environmental space. As shown in FIG. 5 the environment analysis unit 22 includes a storage 221, a device for detecting space and a comparison unit 220. The device for detecting space is used to detect space value. The comparison unit 220 finds out corresponding adjusting parameters in the plurality of characteristic data sets, the parameters are corresponding to the space value, when a minimum discrepancy between a second image and the first image among the plurality of images, the environment analysis unit 22 selects a second environmental adjusting parameter from the plurality of environmental adjusting parameters according to the second image and transmits the second environmental adjusting parameter to the volume control unit 20. The device for detecting space is used to detect the environmental space, that is, the audio/video play device 3, and the device for detecting space can be an ultrasonic detecting module that can calculates the distance between the sent ultrasonic signal and the received ultrasonic signal, and they are well-known already. Moreover, adjusting volume magnitude is made according to the dimensions of the space so as to satisfy the requirements of the audience.

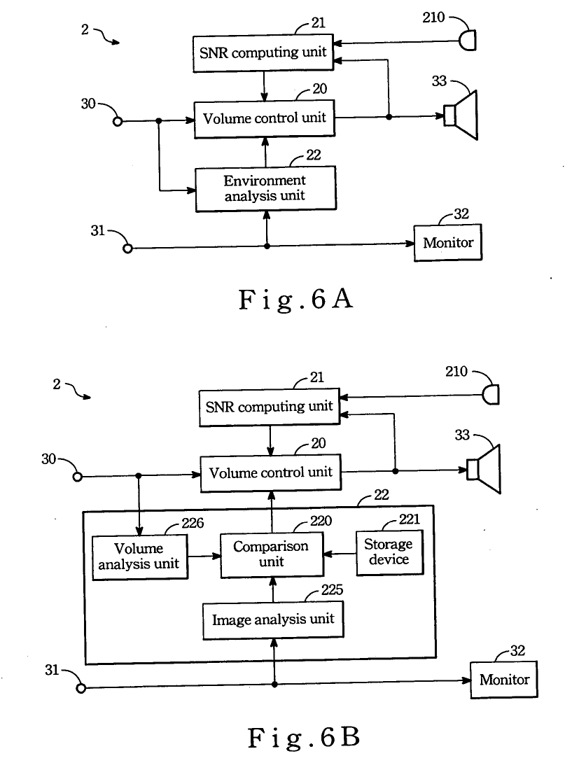

Moreover, the audience may have different audio perception requirements according to the contents of different programs. Please refer to FIG. 6A and FIG. 6B, both illustrate two schematic system block diagrams of a forth preferred embodiment of the audio/video system of the present invention. In FIG. 6A, the environment analysis unit 22 is electrically connected to an audio source 30 and a video source 31 so as to let the first audio signal and the video signal be inputted. That is, the characteristic data sets include the video signals and the first audio signals to recognize the content of real-time live program and to adjust audio volume dynamically.

As shown in FIG. 6B, the image analysis unit 225 is used to input the video signal. The image analysis unit 225 is for estimating a motion rate of the video signal, wherein the comparison unit 22 selects the environmental adjusting parameters according to the motion rate, the motion rate of the video signal corresponding to the gray gradient of a plurality of pixels is changed in different images during a unit time period, and continuously the image analysis unit 225 outputs the analysis result to the comparison unit 220. The comparison unit 220 finds out the correspondent environmental adjusting parameters in the storage 221, and outputs them to the volume control unit 20. The real time motion analysis will divide the video signals of an image into a plurality of pixels, detect and calculate the changed amount of the gray gradient. The changed amount is to judge the changed extent of images. For example, if there is a scene that is great and majestical, the volume adjusting system 2 may give a higher magnitude of volume so as to satisfy the perception requirements of the audience.

The volume analysis unit 226 is used to input the first audio signal. The volume analysis unit 226 can integrate the first audio signal in a unit time to produce the environmental adjusting parameter, and output the integration result into the comparison unit 220. The comparison unit 220 finds, according to the integration result, out the corresponding environmental adjusting parameters in the storage device 221, and outputs them to the volume control unit 20, Therefore, according to the judgment on the first audio signal, the present contents of a program can be known, and an appropriate magnitude of volume can be made.

Through the above various embodiments, it can be known that the audio/video system of the present invention can use various characteristic data sets, and further adjust volume magnitude, in which the characteristic data sets including the sex, age, identification, mood change of the audience, and the contents of programs. Therefore, the present invention brings the audio adjusting mechanism of the audio/video play device into a new era.

While the present invention has been particularly shown and described with reference to a preferred embodiment, it will be understood by those skilled in the art that various changes in form and detail may be without departing from the spirit and scope of the present invention.

I claim:

1. An audio/video system having a first audio signal and a video signal, the audio/video system comprising:
an environment analysis unit for receiving at least one environmental data set and producing an environmental adjusting parameter according to the environmental data set;
a volume control unit generating a second audio signal according to the environmental adjusting parameter and the first audio signal; and
an SNR computing unit for calculating an SNR according to the second audio signal and an environmental volume magnitude, the SNR being for adjusting the output value of the second audio signal.

2. The system according to claim 1 further comprising:
a speaker, the volume control unit outputting the second audio signal to the speaker.

3. The system according to claim 2, the SNR computing unit further comprising:
a sound detecting module for detecting the environmental volume magnitude, and the environmental volume magnitude being a sum of the magnitude of the second audio signal outputted by the speaker and a noise value.

4. The system according to claim 3, wherein the sound detecting module is selected from one of the group of: electric type, carbon powder type, capacity type, and piezoelectric type.

5. The system according to claim 3, wherein the SNR is a ration of the second audio signal to the noise value, and when the SNR is lower, the output value of the second audio signal is adjusted to be higher, when the SNR is higher, the output value of the second audio signal is adjusted to be lower.

6. The system according to claim 1, the environment analysis unit further comprising:
a storage device for storing a plurality of characteristic data sets and a plurality of corresponding environmental adjusting parameters.

7. The system according to claim 6, the environment analysis unit further comprising:
a set up interface audience for a audience setting up a first environmental data set, including the age and sex of the audience, the environment analysis unit selecting a first environmental adjusting parameter from the plurality of environmental adjusting parameters according to the first environmental data set audience.

8. The system according to claim 6, the storage device further storing a plurality of images corresponding to the plurality of environmental adjusting parameters, the environment analysis unit further comprising:
an image capture device for capturing a first image; and
a comparison unit for comparing the first image with the plurality of images, when a minimum discrepancy is between a second image and the first image among the plurality of images, the environment analysis unit selects a second environmental adjusting parameter from the plurality of environmental adjusting parameters according to the second image and transmits the second environmental adjusting parameter to the volume control unit.

9. The system according to claim 8, wherein the image capture device is selected from one of the group of: CCD and CMOS image sensor.

10. The system according to claim 6, the environment analysis unit further comprising:
a space detecting device for detecting a space value;
wherein the environment analysis unit selects a third environmental adjusting parameter from the plurality of the environmental adjusting parameters according to the space value.

11. The system according to claim 10, wherein the space detecting device is an ultrasonic detecting module.

12. The system according to claim 1, the environment analysis unit further comprising:
an image analysis unit for estimating a motion rate of the video signal, wherein the environment analysis unit selects the environmental adjusting parameters according to the motion rate.

13. The system according to claim 12, wherein the motion rate of the video signal corresponding to the gray gradient of a plurality of pixels is changed in different images during a unit time period.

14. The system according to claim 1, wherein the environment analysis unit integrates the first audio signal in a unit time to produce the environmental adjusting parameter. environment analysis unit

15. An audio/video play device comprising:
a video signal source for generating a video signal;
an audio source for generating a first audio signal; and
an audio adjusting system comprising:
an environment analysis unit, for receiving at least one environmental data set and producing an environmental adjusting parameter according to the environmental data set;
a volume control unit generating a second audio signal according to the environmental adjusting parameter and the first audio signal; and
an SNR computing unit for calculating an SNR according to the second audio signal and an environmental volume magnitude, the SNR being for adjusting an output value of the second audio signal.

16. The audio/video play device according to claim 15 further comprising a speaker, and the volume control unit outputting the second audio signal to the speaker.

17. The audio/video play device according to claim 16, the SNR computing unit further comprising:
a sound detecting module being for detecting the environmental volume magnitude, and the environmental volume magnitude being a sum of the magnitude of the second audio signal outputted by the speaker, and of a noise value.

18. The audio/video play device according to claim 17, wherein the sound detecting module is selected from one of the group of: electric type, carbon powder type, capacity type, and piezoelectric type.

19. The audio/video play device according to claim 17, wherein the SNR is a ration of the second audio signal to the noise value, and when the SNR is lower, the output value of the second audio signal is adjusted to be higher, when the SNR is higher, the output value of the second audio signal is adjusted to be lower.

20. The audio/video play device according to claim 15, the environment analysis unit further comprising:
a storage device for storing a plurality of characteristic data sets and a plurality of corresponding environmental adjusting parameters.

21. The audio/video play device according to claim 20, the environment analysis unit further comprising:
a set up interface for an audience setting up a first environmental data set, including the age and sex of the audience, the environment analysis unit selecting a first environmental adjusting parameter from the plurality of environmental adjusting parameters according to the first environmental data set environment analysis unit audience.

22. The audio/video play device according to claim 20, the storage device further storing a plurality of images corresponding to the plurality of environmental adjusting parameters, the environment analysis unit further comprising:
an image capture device for capturing a first image; and
a comparison unit for comparing the first image with the plurality of images, when a minimum discrepancy between a second image and the first image among the plurality of images, the environment analysis unit selects a second environmental adjusting parameter from the plurality of environmental adjusting parameters according to the second image and transmits the second environmental adjusting parameter to the volume control unit.

23. The audio/video play device according to claim 22, wherein the image capture device is selected from one of the group of: CCD and CMOS image sensor.

24. The audio/video play device according to claim 20, the environment analysis unit further comprising:
a space detecting device for detecting a space value;
wherein the environment analysis unit selects a third environmental adjusting parameter from the plurality of the environmental adjusting parameters according to the space value.

25. The audio/video play device according to claim 24, wherein the space detecting device is an ultrasonic detecting module.

26. The audio/video play device according to claim 15, wherein the environment analysis unit further comprising:
an image analysis unit for estimating a motion rate of the video signal, wherein the environment analysis unit selects the environmental adjusting parameters according to the motion rate.

27. The audio/video play device according to claim 26, wherein the motion rate of the video signal corresponding to the gray gradient of a plurality of pixels is changed in different images during a unit time period.

28. The audio/video play device according to claim 15, wherein the environment analysis unit integrates the first audio signal in a unit time to produce the environmental adjusting parameter.
